(19) United States
(12) Patent Application Publication
(10) Pub. No.: US 2019/0046821 A1
(43) Pub. Date: Feb. 14, 2019

(54) Flexible Drain-pipe Conduit for Fire Suppression Sprinkler Systems

(71) Applicant: Globe Fire Sprinkler Corporation, Standish, MI (US)

(72) Inventors: Stephen J. MEYER, Chester Springs, PA (US); Ralph WATSON, Newnan, GA (US); Stewart YOUNG, Lake Geneva, WI (US)

(21) Appl. No.: 16/056,948

(22) Filed: Aug. 7, 2018

Related U.S. Application Data
(60) Provisional application No. 62/543,619, filed on Aug. 10, 2017.

(51) Int. Cl. A62C 31/00; F16K 11/00

(52) U.S. Cl. CPC A62C 31/00; F16K 11/00

(57) ABSTRACT

A multi-valve manifold assembly for a fire suppression sprinkler system having a wet standpipe, sprinklers and a drain-pipe riser, has inlet piping in fluid communication with the wet standpipe. A control valve is in fluid communication with the inlet piping. Outlet piping is in fluid communication with the control valve and the sprinklers. A drain valve is in fluid communication with the outlet piping. A flexible drain-pipe conduit has a flexible drain-pipe-conduit inlet in fluid communication with the drain valve and a flexible drain-pipe-conduit outlet in fluid communication with the drain-pipe riser.

### CROSS-REFERENCE TO RELATED APPLICATIONS

This application claims the benefit of priority under 35 USC § 119(e) of U.S. Provisional Patent Application No. 62/543,619 filed Aug. 10, 2017, the contents of which are incorporated herein by reference.

### BACKGROUND OF THE INVENTION

The present invention is generally directed to a flexible drain-pipe conduit for fire suppression sprinkler systems, and more particularly to a fire suppression sprinkler systems having a flexible drain-pipe conduit fluidly connecting a drain valve of a sprinkler system to a drain-pipe riser.

Fire suppression sprinkler systems designed for protection of commercial and non-commercial multi-floor properties have a wet standpipe that extends generally vertically through the floors of the property and a large multi-valve manifold assembly that branches off the standpipe at each of the respective floors. The multi-valve manifold assembly of each respective floor connects water in the standpipe to the sprinklers on that respective floor and provides access to a drain-pipe riser.

The typical multi-valve manifold assembly includes some combination or all of the following components: a control valve, a check valve, a water flow detection switch, a test valve, a drain valve and a pressure relief valve. The control valve is utilized to allow water flow to the sprinklers downstream thereof to be shut off, e.g., for maintenance purposes. The check valve retains fluid and pressure downstream in the fire protection system so that during periods, such as supply side system maintenance, fluid and pressure are retained in the system downstream of the check valve. The flow detection switch is utilized at least to sound an alarm when the sprinklers are activated. The test valve is utilized for testing of the sprinkler system and the drain valve is utilized for draining the sprinkler system, e.g., also for maintenance purposes. The pressure relief valve is utilized to ensure that the water pressure within the sprinkler system does not surpass a safe level.

The foregoing components are available individually from various commercial suppliers. Conventionally, the test and drain valves, the pressure relief valve and the water flow detection switch are mounted separately to respective conduits along a large manifold/network of piping proximate the control valve and/or check valve during installation of sprinkler systems. (See, FIG. 1) The portion of the multi-valve manifold assembly providing access to a drain-pipe riser is field fit after the other components have been installed. (See, FIG. 2) Consequently, the multi-valve manifold assembly has a relatively large footprint, is costly to manufacture and is both time consuming, complicated and costly to assemble.

As one example, of a conventional installation, the largest sprinkler system control valves (eight inches or more in diameter), in combination with the piping manifold, conduits and accessories mounted thereon, typically weigh several hundred pounds.

While an innovative design of a modular valve assemble had been developed (see, FIG. 3; see also U.S. patent application Ser. No. 15/402,840, attached hereto) and a universal test and drain valve assembly (see, U.S. Patent Application No. 62/443,326 and Globe Model UTD Test and Drain Data Sheet GFV-570, attached hereto) to reduce the footprint of a conventional sprinkler system installation, there remains a need to eliminate excess manifold piping fluidly connecting the drain valve to a drain-pipe riser.

### BRIEF SUMMARY OF THE INVENTION

Briefly stated, one embodiment of the present invention is directed to a multi-valve manifold assembly for a fire suppression sprinkler system having a wet standpipe, sprinklers and a drain-pipe riser, has inlet piping in fluid communication with the wet standpipe. A control valve is in fluid communication with the inlet piping. Outlet piping is in fluid communication with the control valve and the sprinklers. A drain valve is in fluid communication with the outlet piping. A flexible drain-pipe conduit has a flexible drain-pipe-conduit inlet in fluid communication with the drain valve and a flexible drain-pipe-conduit outlet in fluid communication with the drain-pipe riser.

### BRIEF DESCRIPTION OF THE DRAWINGS

The following detailed description of preferred embodiments of the invention will be better understood when read in conjunction with the appended drawings. It should be understood, however, that the invention is not limited to the precise arrangements and instrumentalities shown. In the drawings:

FIG. 1 is a perspective front and side elevation view of a prior art multi-valve manifold assembly for a fire suppression sprinkler systems;

FIG. 2 is an enlarged, perspective front and side elevation view of a portion of the multi-valve manifold assembly of FIG. 1 showing the drain valve outlet piping fluidly connecting the drain valve to a drain-pipe riser;

FIG. 3 is a perspective front and side elevation view of a prior art two piece modular control valve assembly as shown in FIG. 1 of U.S. patent application Ser. No. 15/402,840;

FIG. 4 is side elevation view of a preferred embodiment of a flexible drain-pipe conduit configured to replace the manifold piping of FIG. 2 fluidly connecting the drain valve to the drain-pipe riser;

FIG. 5 is an assembly drawing for the flexible drain-pipe conduit of FIG. 4;

FIG. 6 is a digital image of a plurality of flexible drain-pipe conduits manufactured in accordance with FIG. 5;

FIG. 7 is an enlargement of right end of a flexible drain-pipe conduit in FIG. 6; and

FIG. 8 is a reproduction of FIG. 2 showing the drain valve outlet piping replaced by the flexible drain-pipe conduit in FIG. 4.

### DESCRIPTION OF THE DISCLOSURE

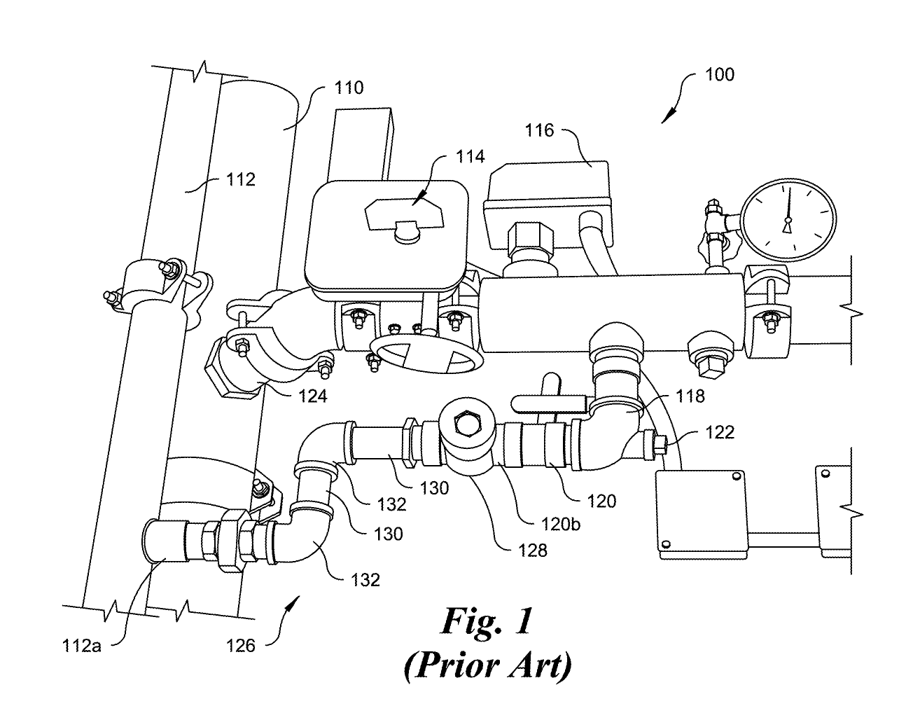

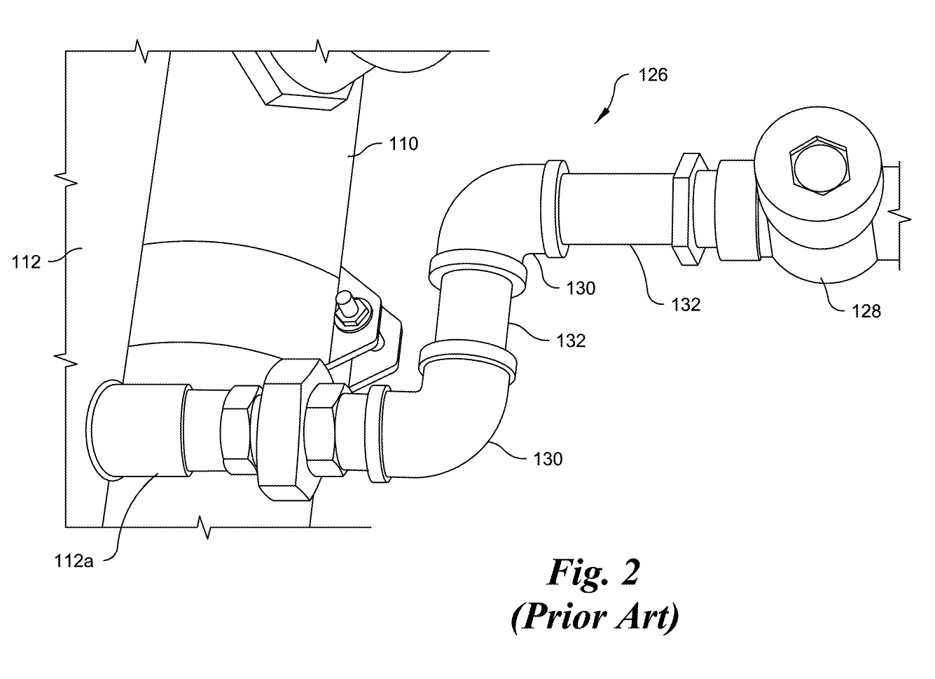

Referring to the drawings in detail, wherein like numerals indicate like elements throughout, there is shown in FIGS. 1 and 2 a typical multi-valve manifold assembly 100 for one floor of a fire suppression sprinkler systems designed for protection of multi-floor properties have a wet standpipe 110 and drain-pipe riser 112 that extend generally vertically through the floors of the property. The multi-valve manifold assembly 100 branches off the standpipe 110, connecting water in the standpipe 110 to sprinklers (not shown) on the floor and provides access to the drain-pipe riser 112. The typical multi-valve manifold assembly 100 includes a control valve 114, a check valve (not shown), a water flow detection switch 116, a test valve 118, a drain valve 120 and a pressure relief valve 122. A portion of the multi-valve manifold assembly includes control-valve inlet piping 124 fluidly connecting the control valve 114 to the wet standpipe 110. Another portion of the multi-valve manifold assembly, an enlargement of which is shown in FIG. 2, includes drain-valve outlet piping 126 fluidly connecting the drain valve 120 to the drain-pipe riser 112 through the intervening drain-pipe check valve 128.

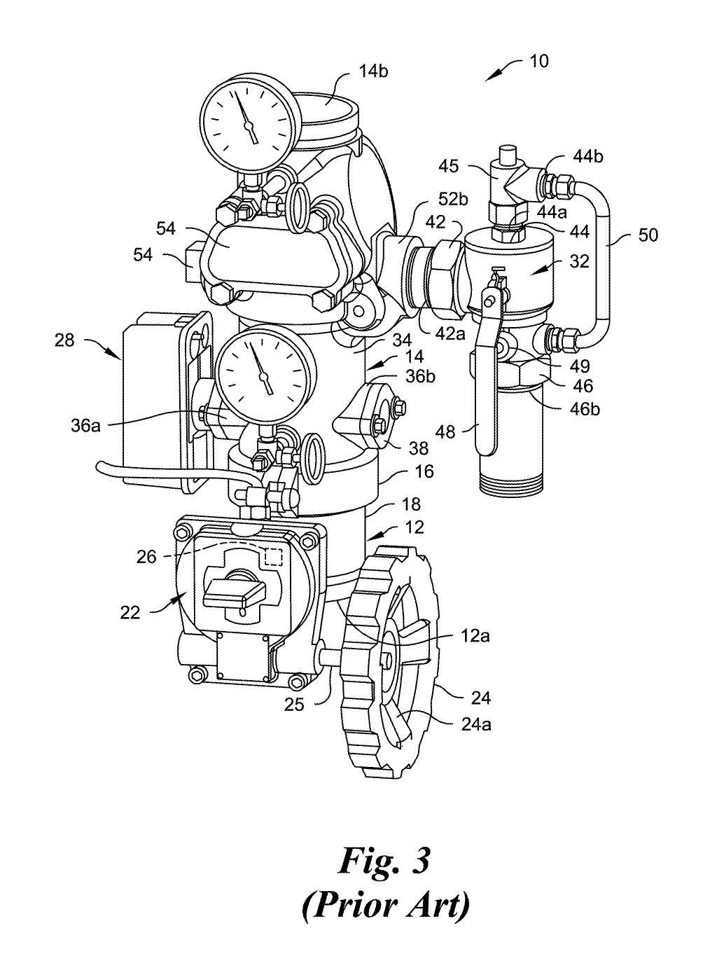

An innovative design of a modular valve assemble (MVA) 10 shown in FIG. 3, briefly below and described in detail in U.S. patent application Ser. No. 15/402,840, has a smaller footprint than the footprint of the multi-valve manifold 100 of FIG. 1 and is a replacement for the typical multi-valve manifold assembly 100, the MVA 10 does not address the reduction of the complexity and footprint for the drain-valve outlet piping 128 shown in FIG. 2.

Generally, the MVA 10 is utilized in a wet standpipe (not shown) for a multi-floor property sprinkler system (not shown). As should be understood by those of ordinary skill in the art, the wet standpipe extends generally vertically through the floors of the property, and an MVA 10 branches off of the wet standpipe at each of the respective floors. Each MVA 10 of a respective floor connects water in the standpipe with the sprinklers on that respective floor. The MVA 10 may also control draining of the sprinkler system for testing and maintenance, and where the MVA 10 includes a control valve (as described in detail further below), the MVA 10 may also control shutting off water flow to the sprinklers, e.g., at the end of a fire.

The MVA 10 of FIG. 3 is comprised of two main components: an upstream control assembly 12 in series with a downstream check valve assembly 14, connected together by a mechanical coupling 16 in a manner well understood by those of ordinary skill in the art. The control assembly 12 defines a main inlet 12a of the MVA 10 at a base end thereof (according to the orientation of the MVA 10 depicted in FIG. 3) for receiving water from the wet standpipe, and the check valve assembly 14 defines a main outlet 14b of the MVA 10 at an uppermost end thereof (according to the same orientation of the MVA 10 depicted in FIG. 3), through which water exits from the MVA 10 to the sprinklers (not shown). In the illustrated embodiment, both ends 12a, 14b have respective outer peripheral grooves for mating in a conventional fashion with other fittings or pipe lengths. Alternatively, the ends 12a, 14b could be threaded, flanged or the like for other types of conventional mating.

The check valve assembly 14 has a generally tubular, single piece, e.g., integral, unitary and monolithic, valve body 34. The single piece valve body 34 fluidly connects or houses three main components of the MVA 10: a flow detection switch 28 that detects waterflow from the inlet 12a to the outlet 14b of the MVA 10 and alarm, a check valve (not shown in FIG. 3) positioned within the valve body 34 and preventing the backflow of water in the MVA 10, and a test, drain and pressure relief module 32.

The test, drain and pressure relief module 32 is fluidly connected with the valve body 34 of the check valve assembly 14 downstream of flow detection switch 28 (and downstream of the check valve and upstream of the outlet 14b of the MVA 10. The module 32 includes three fluidly connectable ports 42, 44, 46 and an internal flow valve 40, which directs the flow between the three ports and is controlled by lever 48.

The first port 42 of the module 32 (labeled “test” in FIG. 3) is fluidly connected at an inlet side 42a thereof to the check valve assembly 14 downstream from the check valve in the valve body 34, and operates as the inlet port for the module 32. When the lever 48 is oriented in the “test” position, water from the check valve assembly 14 and the sprinklers flows into the module 32 from the first port 42 in a restricted manner and exits the module 32 through the outlet 46b of third port 46. An outlet 44b of the second port 44 (labeled “off” in FIG. 3) is fluidly connected via external piping 50 with the third port 46 for pressure relief. The third port 46 (labeled “drain” in FIG. 3) fluidly connects the first port 42 with a drainage pipe (not shown), and operates as the exit port for the module 32. When the lever 48 is oriented in the “drain” position, water drains out from the check valve assembly 14 and sprinklers and into the module 32 in an unrestricted manner via the first port 42 and exits the module 32 through the third port 46.

A detailed disclosure of the MVA 10 may be found in U.S. patent application Ser. No. 15/402,840 attached hereto. A detailed disclosure of the test, drain and pressure relief module 32 may be found in U.S. Patent Application No. 62/443,326.

Neither the typical multi-valve manifold assembly of FIG. 1 nor the MVA of FIG. 3 addresses the reduction of the structural complexity and footprint for the drain-valve outlet piping shown in FIG. 2. However, the drain-valve outlet piping may be replaced by the flexible drain-pipe conduit of the present invention.

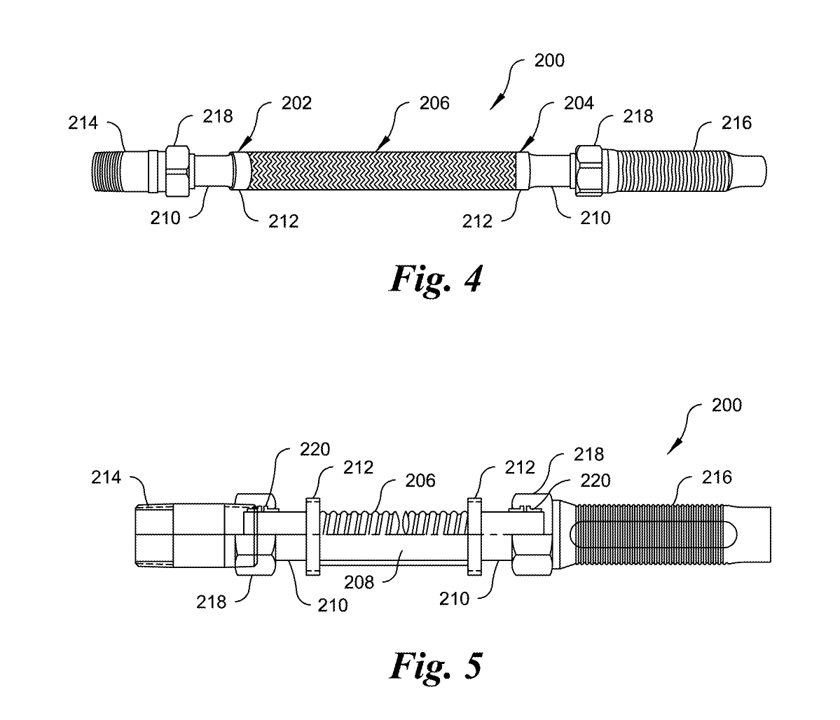

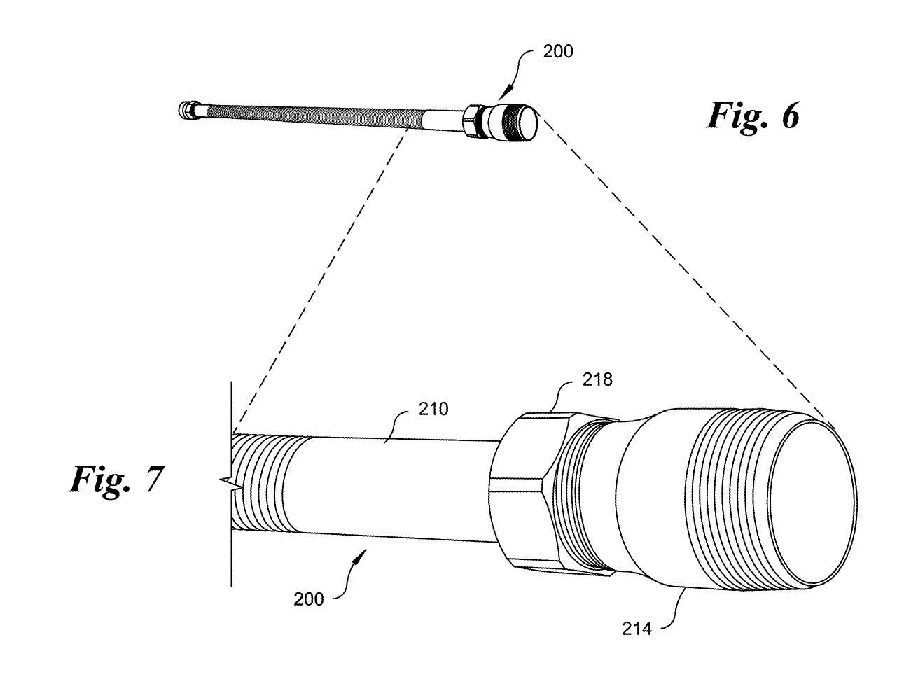

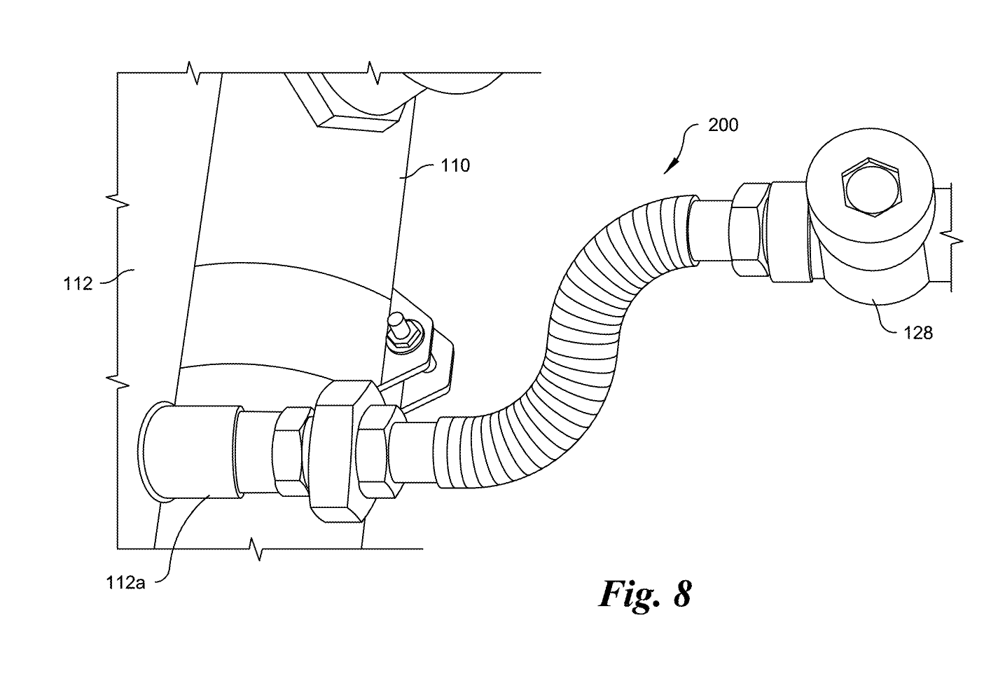

Referring to FIGS. 4-8, a flexible drain-pipe conduit, generally designated 200, and hereafter referred to as the “conduit 200” in accordance with a preferred embodiment of the present invention is shown therein. The conduit 200 is configured to replace the drain-valve outlet piping 128 of both the multi-valve manifold assembly 100 of FIG. 1 and the MVA 10 of FIG. 3 and similar multi-valve manifold assembly having at least inlet piping 124 in fluid communication with a wet standpipe 110, a control valve 114 in fluid communication with the inlet piping 124, outlet piping in fluid communication with the control valve 114 and the sprinklers, and a drain valve 120 in fluid communication with the outlet piping. In accordance with preferred embodiments of the present invention, such multi-valve manifold assemblies have a flexible drain-pipe conduit 200 having a flexible drain-pipe-conduit inlet 202 in fluid communication with the drain valve 120 and a flexible drain-pipe-conduit outlet 204 in fluid communication with the drain-pipe riser 112.

Referring to FIGS. 4 and 5, preferably, the flexible drain-pipe conduit 200 comprises a corrugated tube 206 with a braided hose outer covering 208. The flexible drain-pipe-conduit inlet 202 and flexible drain-pipe-conduit outlet 204 are attached to flexible drain-pipe-conduit nipples 210 by a clamp 212. In some embodiments, he flexible drain-pipe conduit inlet 202 is attachable to the drain valve 120 by a threaded inlet nipple 214 and the flexible drain-pipe-conduit outlet 204 is attachable to the drain-pipe riser by a threaded reducer 216. Slit-nuts 218 or other suitable fasteners attach the flexible drain-pipe-conduit nipples 210 to the threaded inlet nipple 214 and the threaded reducer 216. An isolation ring may be disposed in the slit-nuts. Although the flexible drain-pipe conduit is preferably fabricated in fixed lengths, in some applications, the pipe length may be determined and trimmed in the field to fit and the appropriate connectors attached to each end of the pipe by a compression or swage fit at the time the sprinkler system is being installed.

The conduit 200 is a flexible pipe may terminate in male and/or female connectors. The pipe may be fabricated from any material that is in compliance with the requirements set forth in the National Fire Protection Association code for manifold pipe for fire suppression sprinkler systems. Preferably, the pipe is a corrugated pipe fabricated from stainless steel and may have a braided covering. In some instances the covering may have a red color.

Typically, the drain-valve outlet piping 126 has a generally S-like shape and comprises a plurality of straight nipples 130 and elbows 132 as required to provide a fluid conduit connecting the drain-valve outlet 46b, 120b to the drain-pipe riser inlet 112a. In use, the conduit 200 is sized and the pipe thereof flexed to confirm to the configuration of the conventional drain-valve outlet piping 126 it is replacing.

It will be appreciated by those skilled in the art that changes could be made to the embodiment described above without departing from the broad inventive concept thereof. It is understood, therefore, that the invention is not limited to the particular embodiment disclosed, but it is intended to cover modifications within the spirit and scope of the disclosure.

All references, patent applications, and patents mentioned above are incorporated herein by reference in their entirety and are not to be construed as an admission that any of the cited documents constitutes prior art, or as an admission against interest in any manner.

We claim:

1. A multi-valve manifold assembly for a fire suppression sprinkler system having a wet standpipe, sprinklers and a drain-pipe riser, the multi-valve manifold assembly comprising:
inlet piping in fluid communication with the wet standpipe;
a control valve in fluid communication with the inlet piping;
outlet piping in fluid communication with the control valve and the sprinklers;
a drain valve in fluid communication with the outlet piping; and
a flexible drain-pipe conduit having a flexible drain-pipe-conduit inlet in fluid communication with the drain valve and a flexible drain-pipe-conduit outlet in fluid communication with the drain-pipe riser.

2. The multi-valve manifold assembly of claim 1, wherein the flexible drain-pipe conduit comprises a corrugated tube with a braided hose outer covering.

3. The multi-valve manifold assembly of claim 2, wherein flexible drain-pipe-conduit inlet and flexible drain-pipe-conduit outlet are attached to flexible drain-pipe-conduit nipples by a clamp.

4. The multi-valve manifold assembly of claim 1, wherein the flexible drain-pipe conduit inlet is attachable to the drain valve by a threaded inlet nipple and the flexible drain-pipe-conduit outlet is attachable to the drain-pipe riser by a threaded reducer.

5. The multi-valve manifold assembly of claim 4, wherein slit-nuts attach the flexible drain-pipe-conduit nipples to the threaded inlet nipple and the threaded reducer.

6. The multi-valve manifold assembly of claim 5, wherein an isolation ring is disposed in the slit-nuts.

7. The multi-valve manifold assembly of claim 1, wherein the flexible drain-pipe conduit is fabricated in fixed lengths.
